(19) United States
(12) Patent Application Publication
(10) Pub. No.: US 2026/0150059 A1
(43) Pub. Date: May 28, 2026

(54) METHOD OF A VEHICLE FOR CONTROLLING THE TRANSMISSION POWER DURING THE COMMUNICATION WITH A VEHICLE KEY, AS WELL AS VEHICLE AND VEHICLE KEY

(71) Applicant: Volkswagen Aktiengesellschaft, Wolfsburg (DE)

(72) Inventor: Marek Grünewald, Wolfsburg (DE)

(21) Appl. No.: 19/390,537

(22) Filed: Nov. 15, 2025

(30) Foreign Application Priority Data
Nov. 22, 2024 (DE) 102024134422.9

(51) Int. Cl. H04W 52/30; B60R 25/24; H04B 1/38

(52) U.S. Cl. CPC H04W 52/30; B60R 25/246; H04B 1/38

(57) ABSTRACT

A vehicle-based communication system supports wireless data exchange with a vehicle key using ultra-high-frequency (UHF) radio. A control unit of the vehicle transmits a first message to a communication control device, the message indicating a transmission power to be set for a transceiver. The communication control device sets the UHF transmission power based on the message and activates the transceiver to transmit a data packet containing user data to the vehicle key. A low-frequency ping may establish a receive window during which the vehicle key receives the data packet. The vehicle key stores the received data packet, optionally transmits a checksum to confirm proper reception, and may adjust its own UHF transmission power based on the received data. The vehicle may re-transmit the data packet when an incorrect checksum is detected. The system enables flexible, software-based adjustment of UHF transmission power for reliable communication with the vehicle key.

### RELATED APPLICATIONS

The present application claims priority to German Patent Application No. DE 10 2024 134 422.9, to Marek Grünewald, filed Nov. 22, 2024, the contents of which is incorporated by reference in its entirety herein.

### TECHNICAL FIELD

The present disclosure relates to a method performed by a vehicle for controlling transmission power during communication with a vehicle key. The present disclosure further relates to a vehicle configured to carry out such a method, to a vehicle key configured for communication with the vehicle, and to a system including such a vehicle and such a vehicle key.

### BACKGROUND

Electronic vehicle keys are widely used, and the use of smartphones as vehicle keys has become increasingly common, offering a variety of convenient functions. For example, such devices may enable contactless access to the vehicle or allow data relevant to servicing or repairing the vehicle to be stored and retrieved in repair facilities.

During communication between the vehicle and the vehicle key, it is advantageous to regulate the transmission power to optimize the energy efficiency of the vehicle key and extend battery life, thereby improving user convenience and contributing to sustainable operation. Adjusted transmission power may also support compliance with applicable regulatory requirements and may help minimize interference with other electronic devices, promoting reliable communication between the key and the vehicle.

Conventional approaches primarily focus on controlling transmission power at the vehicle key to maximize energy efficiency. For example, US 2009/0243796 A1 describes a method in which the transmission power of a vehicle key is adapted based on a distance between the key and the vehicle. It is further proposed to incrementally increase the transmission power of the key until feedback from the vehicle is received, or to adjust the power based on the received signal strength. Another document, CN 117912143 A, proposes controlling transmission power based on gear-selection information from the vehicle so as to place the key into an energy-saving mode, for example when the vehicle is not in a parking state.

However, many countries have established specific legal requirements governing maximum permissible radio-frequency transmission power, particularly in the UHF frequency range and when transmitting larger amounts of data. At the same time, it remains necessary to ensure that data are transmitted reliably and without error.

### SUMMARY

Aspects of the present disclosure are directed toward reducing disadvantages of prior approaches and providing a method, a vehicle, a vehicle key, and a system that support efficient and regulation-compliant communication between the vehicle and the vehicle key.

Some aspects of the present disclosure relate to a method performed by a vehicle. Within the meaning of the present disclosure, a vehicle may be any means of transportation configured to transport persons and/or loads on land, in the air, and/or in space. In preferred examples, the vehicle is a passenger car that includes an internal combustion engine, an electric motor, or a hybrid motor.

The vehicle comprises a control unit and a communication system that includes a communication control device and a transceiver. The transceiver is configured for ultra-high-frequency (UHF) communication with a vehicle key. A vehicle key, as used herein, is preferably an electronic vehicle radio key implemented either as a stand-alone device or within a user terminal, such as a smartphone. The transceiver may additionally be configured for direct or indirect wireless communication with the key in one or more frequency ranges outside the UHF range.

The method includes transmitting, by the control unit, a first message to the communication control device. The first message preferably includes data indicating a UHF transmission power to be set by the transceiver, and in preferred cases includes one or more binary flags. The first message is preferably implemented as a Controller Area Network (CAN) message transmitted via a CAN bus of the vehicle, and more preferably via a private CAN bus between the control unit and the communication system.

In preferred examples, the control unit transmits the first message in response to a command from a central control device of the vehicle. That is, the control unit generates the first message, sets one or more binary flags based on the received command, and then forwards the message to the communication control device. The command may direct the transmission of data to the vehicle key. The central control device may be implemented as a stand-alone controller of the vehicle or as part of the control unit.

In some examples, the central control device transmits commands to the control unit cyclically. For instance, the central control device may periodically issue a command instructing the control unit to transmit current vehicle data to the vehicle key so that the data may be retrieved during a service visit. Transmission of the command may additionally depend on a vehicle property, such as a current vehicle speed. In one example, the command to transmit vehicle data is issued only above a predetermined speed and after a predetermined time interval has elapsed since engine start.

The method further includes setting a UHF transmission power of the transceiver. The communication control device sets the transmission power based on the data contained in the first message. For this purpose, the communication control device preferably reads the data contained in the first message that indicate a UHF transmission power to be set and adjusts the output power of the transceiver accordingly.

In some examples, a computer program is disclosed that includes instructions which, when executed by a computer such as a vehicle control unit, cause the computer to perform the method described herein.

Some aspects of the present disclosure further relate to a vehicle configured to perform the method described above. As noted, the vehicle may be any suitable means of transportation and is preferably a passenger car having an internal combustion engine, an electric motor, or a hybrid motor. The vehicle comprises a control unit, a communication system with a communication control device, and a transceiver configured for UHF communication with a vehicle key, which may be implemented as a stand-alone key or within a user terminal such as a smartphone. The transceiver may additionally support wireless communication in other frequency bands.

The control unit is configured to transmit the first message to the communication control device. The first message preferably includes data, particularly binary flags, indicating a UHF transmission power to be set. The message may be a CAN message transmitted via a private or general CAN bus of the vehicle. The control unit may transmit the message based on a command from a central control device, which may be implemented either separately or as part of the control unit. As described above, the central control device may transmit such commands cyclically or conditionally based on vehicle properties such as speed or elapsed operating time.

The communication control device is configured to set the UHF transmission power of the transceiver based on the first message, including reading the relevant data from the message and adjusting the output power accordingly.

In some examples, a system is disclosed that includes a vehicle and a vehicle key as described herein. The system may include multiple vehicle keys, such as a first and second key, each configured in accordance with the examples described above.

Preferred specific embodiments of the disclosed system correspond, mutatis mutandis, to the preferred embodiments described for the vehicle and for the vehicle key and may achieve the same advantages. Repetition of these details is therefore omitted for the sake of clarity.

Additional preferred embodiments are derived from the remaining features recited in the dependent claims.

Unless otherwise indicated, the various specific embodiments described in the present application may be combined with one another.

### BRIEF DESCRIPTION OF THE DRAWINGS

The present disclosure will be described hereafter in exemplary embodiments with reference to the accompanying drawings. In the drawings:

FIG. 1 shows a schematic representation of a method performed by a vehicle according to one specific embodiment, according to some aspects of the present disclosure.

FIG. 2 shows a schematic representation of a vehicle and a system including the vehicle and a vehicle key according to one specific embodiment, according to some aspects of the present disclosure.

FIG. 3 shows a schematic representation of a vehicle key according to one specific embodiment, according to some aspects of the present disclosure.

FIG. 4 shows a flow chart illustrating a method performed by a vehicle according to one specific embodiment, according to some aspects of the present disclosure.

### DETAILED DESCRIPTION

The following detailed description provides exemplary embodiments that illustrate how the features of the present disclosure may be implemented in practice. These examples are provided for explanatory purposes and are not intended to limit the scope of the present disclosure.

In some examples, the disclosed method provides a software-based mechanism for application-specific adjustment of a transmission power used for UHF communication with a vehicle key. Because the transmission power can be set in software rather than through dedicated hardware components, the approach may reduce energy consumption, save installation space, and improve overall system efficiency and sustainability.

In certain examples, the method includes transmitting a second message from the control unit to the communication control device. The second message is preferably implemented as a CAN message sent over a CAN bus of the vehicle, and particularly preferably over a private CAN bus between the control unit and the communication system. The second message may include user data, such as vehicle-related data, that enable contactless vehicle access or facilitate evaluation in a repair facility.

The method may further include activating the transceiver by the communication control device to send a data packet to the vehicle key at the previously set UHF transmission power. In this process, the communication control device evaluates the second message and generates a data packet from the user data it contains. The transceiver then transmits the data packet to the vehicle key using the selected UHF transmission power.

In some implementations, multiple data packets may be generated from the user data and transmitted by the transceiver using the set UHF transmission power. The communication control device may determine the number of data packets based on information contained in the first message. Activation of the transceiver is preferably carried out via an internal data link of the communication system, particularly via a serial peripheral interface (SPI) bus between the communication control device and the transceiver.

Before transmission of the data packet, a communication link to the vehicle key may be established and/or tested, for example using at least one ping message. Additionally or alternatively, the vehicle and/or the vehicle key may undergo an authentication process. Establishing or testing the link and/or performing authentication may be carried out using low-frequency (LF) radio communication.

After the data packet has been transmitted, the communication control device may reset the transceiver transmission power to a standard UHF transmission power. In other words, although the transceiver is ordinarily configured to operate at a standard transmission power, the communication control device may temporarily adjust this power for the transmission of a specific data packet and then restore the standard level afterward.

The method of this example therefore enables selection of an application-specific transmission power based on the user data to be transmitted.

In some examples, the UHF transmission power is set as one of at least two predetermined UHF transmission powers. For this purpose, the communication control device may select among two or more parameter data sets, each corresponding to a predetermined transmission power. The first message may include at least one binary flag, and based on this flag, the communication control device may select a parameter data set, preferably from a look-up table (LUT), in order to set the UHF transmission power from among a plurality of predetermined values.

This arrangement allows the system to reference specific parameter sets based on jurisdiction-specific regulatory requirements. As a result, the vehicle can flexibly adapt transmission power to ensure compliance with legal requirements in different countries.

In a further example, the UHF transmission power may be selected between a first predetermined transmission power and a second predetermined transmission power, the first being lower than the second. The communication control device may select between two parameter data sets associated with respective transmission power levels. The first message may include exactly one binary flag, and based on that flag, the communication control device may select one of the two parameter data sets, preferably from a LUT.

In some examples, when the first predetermined (lower) UHF transmission power is selected, the second message may include data relating to a service operation for the vehicle. Such service-related data may include information required for diagnostic or maintenance operations and may be retrieved at a repair facility. If the second message includes service-related data, the data packet generated therefrom is preferably transmitted to the vehicle key using the first predetermined transmission power.

Additionally or alternatively, when the second predetermined (higher) UHF transmission power is selected, the second message may include data related to authentication for the vehicle. These data may be used for authenticating the vehicle key to enable contactless vehicle access. If the second message includes authentication-related data, the resulting data packet is preferably transmitted using the second predetermined transmission power.

Two common vehicle-key applications include contactless vehicle access systems (e.g., VW KESSY) and systems used for retrieving current vehicle data for service purposes (e.g., VW Service Key). Different jurisdictions may impose different permissible UHF transmission power limits for these applications due to differences in datagram length and operating conditions. For example, in some countries, a lower transmission power may be required for service-key communication, which is feasible due to the key being located inside the vehicle during such operation. In contrast, contactless vehicle access generally requires a higher transmission power because the key is outside the vehicle. The embodiments described above allow the system to select appropriate transmission power levels for these applications.

In some examples, the second message is transmitted after the first message using a preset time interval. The interval may range from 0 ms to 100 ms, and is particularly preferably between 5 ms and 20 ms. This approach allows the system to set the transmission power before sending user data, which is useful because data transmission is often constrained by a limited time window. This timing may therefore reduce the likelihood of erroneous transmissions.

The method may further include receiving a third message from the vehicle key. The third message is received by the communication control device via the transceiver and may include an acknowledgment (ACK). In some examples, the ACK is a checksum calculated for the transmitted data packet.

Based on the third message, the communication control device may activate the transceiver to re-transmit the data packet. For example, the communication control device may verify the checksum received with the third message and, if the checksum is determined to be incorrect, re-transmit the data packet. To evaluate the checksum, the communication control device may calculate a checksum before transmission of the data packet and temporarily store it in an internal memory. Alternatively, the communication control device may temporarily store the data packet itself for later checksum verification.

This arrangement enables verification of whether the data packet was successfully received by the vehicle key and allows retransmission if it was not, thereby increasing reliability of the overall data communication process.

In some examples disclosed herein, the vehicle may be configured to set a transmission power for UHF communication with a vehicle key in an application-specific manner based on software. Because the transmission power may be set through software rather than dedicated hardware components, the vehicle may dispense with hardware-based transmission-power circuitry. This may reduce energy consumption, free installation space within the vehicle, and therefore contribute to improved overall efficiency and sustainability.

In certain specific embodiments, the control unit operating in combination with the communication system is configured to carry out a method disclosed herein. Preferred specific embodiments of the disclosed vehicle correspond, mutatis mutandis, to the examples of the method disclosed herein and may achieve similar advantages. Repetition of these details is therefore omitted for clarity.

A further aspect of the present disclosure relates to a vehicle key. The vehicle key is preferably an electronic vehicle radio key and may be implemented either as a stand-alone device or within a user terminal, such as a smartphone.

The vehicle key comprises a control device and a transceiver. The transceiver is configured for ultra-high-frequency (UHF) radio communication with the vehicle and may additionally support direct or indirect wireless communication with the vehicle in other frequency ranges outside the UHF band.

The control device is configured to receive, via the transceiver, a data packet transmitted by the vehicle using a predetermined UHF transmission power. The predetermined transmission power may be one of at least two predetermined UHF transmission powers, and may in some examples be one of a larger plurality of predefined values.

In particularly preferred examples, the predetermined UHF transmission power is either a first predetermined transmission power or a second predetermined transmission power, where the first is lower than the second. When a data packet is received using the first predetermined transmission power, the packet may include data relating to a service for the vehicle. Such service-related data may include diagnostic or maintenance information retrievable in a repair facility. Additionally or alternatively, when the data packet is received using the second predetermined transmission power, the packet may include data relating to authentication for the vehicle. Authentication-related data may include information required to authenticate the vehicle key for contactless vehicle access.

Before receiving the data packet, the vehicle key may establish or test a communication link with the vehicle, for example using at least one ping message. Additionally or alternatively, the vehicle and/or the vehicle key may undergo an authentication process. Establishing or testing the link and/or performing authentication may be carried out using low-frequency (LF) radio communication.

In examples disclosed herein, the vehicle key may receive data from the vehicle using different transmission powers. This flexibility allows the transmission power to be adapted to regulatory requirements while also reducing the susceptibility of the communication to transmission errors.

In certain preferred embodiments, the vehicle key further comprises a data memory. The control device may store a received data packet in the data memory, and may store the packet based on the predetermined UHF transmission power with which it was received. In some examples, the control device stores the data packet when it was received using the first predetermined transmission power, for example when the packet contains service-related data.

The control device may further be configured to transmit the stored data packet to an external device via the transceiver. The external device may be a reading device, such as one used in a repair facility. This enables the received data packet to be retrieved and evaluated externally, particularly when it contains data relevant for servicing the vehicle.

In some embodiments, the control device is configured to send a message based on the received data packet back to the vehicle via the transceiver. The message may include an acknowledgment (ACK) based on the data packet. In preferred examples, the ACK is a checksum calculated for the received data packet. Thus, the control device may calculate a checksum for the data packet and transmit the checksum to the vehicle with the ACK.

This arrangement allows the vehicle to determine whether the data packet was properly and completely received by the vehicle key. If the data packet was not correctly received, the vehicle may re-transmit the packet to the vehicle key. This process increases the overall reliability of the communication between the vehicle and the vehicle key.

In a further preferred embodiment, the control device is configured to adjust the UHF transmission power of the transceiver based on the received data packet. For example, the control device may adjust the transmission power to match the UHF transmission power with which the data packet was received. In certain examples, the data packet may include information indicating a transmission power to be set, such as one or more binary flags. The control device may set the transmission power based on such information. The control device may likewise be configured to transmit the ACK or another message derived from the data packet using the adjusted UHF transmission power.

In some embodiments, the control device is configured to ascertain a UHF transmission power corresponding to the received data packet and to process the data packet in accordance with the ascertained transmission power.

In these examples, the vehicle key may communicate with the vehicle using different UHF transmission powers. The transmission power may therefore be flexibly adjusted to satisfy regulatory requirements while minimizing susceptibility to communication errors.

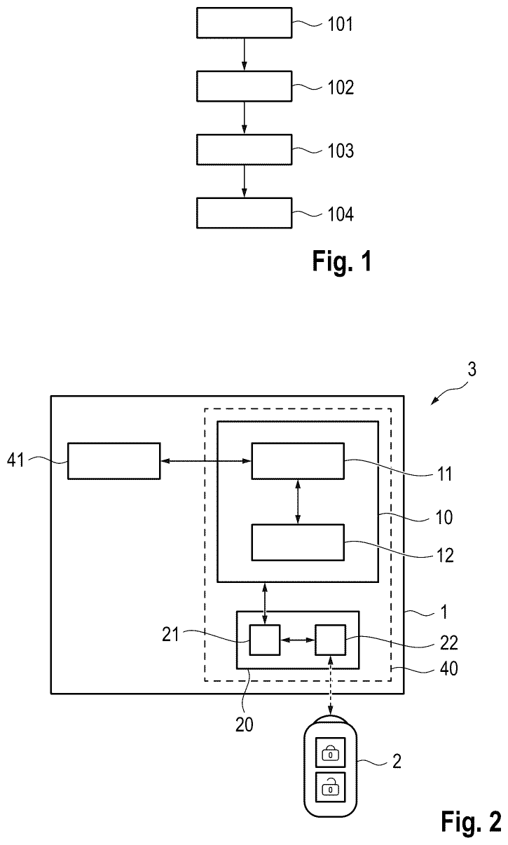

FIG. 1 illustrates a schematic representation of a method performed by a vehicle, such as a passenger car including an internal combustion engine, an electric motor, or a hybrid motor, according to one specific embodiment disclosed herein. The vehicle comprises a control unit and a communication system that includes a communication control device and a transceiver. The transceiver is configured for ultra-high-frequency (UHF) communication with a vehicle key.

The method includes a step 101 of transmitting a first message from the control unit to the communication control device. The first message includes data indicating a UHF transmission power to be set for the transceiver, such as one or more binary flags.

In a subsequent step 102, the method includes setting a UHF transmission power of the transceiver. The communication control device sets the transmission power based on the first message received in step 101. In particular, the communication control device reads the data included in the first message that indicate the UHF transmission power to be set and adjusts the transmission power accordingly.

The method further includes, in step 103, sending a second message from the control unit to the communication control device. The second message may include user data such as vehicle data used for contactless vehicle access or for evaluating vehicle status in a repair facility.

In step 104, the transceiver is activated by the communication control device. During this step, the communication control device evaluates the second message and generates a data packet based on the user data contained therein. The transceiver then sends the resulting data packet to the vehicle key using the UHF transmission power set in step 102.

FIG. 2 illustrates a schematic representation of a vehicle 1 and a system 3 including the vehicle 1 and a vehicle key 2 according to one specific embodiment disclosed herein. The vehicle 1 may be a passenger car including an internal combustion engine, an electric motor, or a hybrid motor.

The vehicle 1 includes a control unit 10 having a CPU 11 and an internal memory 12 that communicate with one another via a suitable data bus. The vehicle 1 further includes a communication system 20 having a communication control device 21 and a transceiver 22. The communication control device 21 and the transceiver 22 may communicate with one another via a suitable data bus, such as an SPI bus. The control unit 10 and the communication system 20 may communicate via a private CAN bus of the body control module (BCM) 40 of the vehicle 1.

The transceiver 22 is configured for UHF communication with a vehicle key 2. The vehicle key 2 may be implemented as an electronic radio key, either as a stand-alone device or within a user terminal such as a smartphone. The transceiver 22 may additionally be configured to communicate directly or indirectly with the vehicle key 2 using other frequency ranges outside the UHF band.

The control unit 10 is configured to transmit data to the communication control device 21 that indicate a UHF transmission power to be set for the transceiver 22. The communication control device 21 is configured to set the UHF transmission power based on these data.

The vehicle 1 further includes a central control device 41. The central control device 41 may be implemented as a stand-alone controller or as part of the control unit 10. The central control device 41 and the control unit 10 may communicate via a suitable data bus.

The central control device 41 is configured to send a command to the control unit 10 to transmit data to the vehicle key 2. Based on this command, the control unit 10 transmits a first message including the data relating to the transmission power to be set to the communication system 20.

In some examples, the central control device 41 transmits commands cyclically. For example, at regular intervals, the central control device 41 may send a command to the control unit 10 to transmit current vehicle data to the vehicle key 2 so that such data may be retrieved in a repair facility.

The control unit 10 is further configured to send user data, such as vehicle data relevant for contactless access or service evaluation, to the communication system 20.

The communication control device 21 is additionally configured to activate the transceiver 22 to send a data packet based on the user data received from the control unit 10 to the vehicle key 2 using the set UHF transmission power.

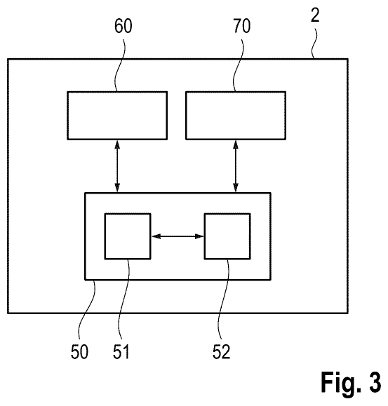

FIG. 3 illustrates a schematic representation of a vehicle key 2 according to one specific embodiment disclosed herein. The vehicle key 2 may be implemented as an electronic vehicle radio key, either as a stand-alone device or within a user terminal such as a smartphone.

The vehicle key 2 includes a control device 50 having a CPU 51 and an internal memory 52, and a transceiver 60. The transceiver 60 is configured for UHF communication with a vehicle and may additionally support direct or indirect wireless communication with the vehicle in frequency bands outside the UHF range.

The control device 50 is configured to receive, via the transceiver 60, a data packet transmitted by the vehicle using a predetermined UHF transmission power.

The vehicle key 2 further includes a data memory 70. The control device 50 is configured to store the received data packet in the data memory 70. In certain examples, the control device 50 is configured to transmit the stored data packet to an external device via the transceiver 60. The external device may be a reading device used, for example, in a repair facility. This enables stored data packets—particularly those containing service-related information—to be retrieved and evaluated.

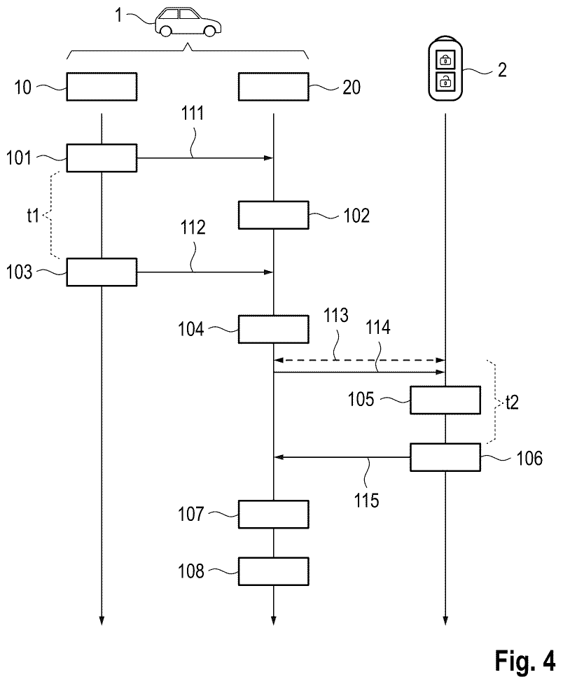

FIG. 4 illustrates a flow chart of a method performed by a vehicle 1 according to one specific embodiment disclosed herein. The vehicle 1 comprises a control unit 10 and a communication system 20 that includes a communication control device and a transceiver.

In a first step 101, a first message 111 is transmitted from the control unit 10 to the communication system 20. The first message 111 is preferably a CAN message and includes data indicating a UHF transmission power to be set for the transceiver, such as one or more binary flags.

In step 102, a UHF transmission power is set by the communication system 20 based on the first message 111 received in step 101. For this purpose, the communication control device reads the data contained in the first message 111 that indicate the UHF transmission power to be set and adjusts the transmission power of the transceiver accordingly.

The method further includes a step 103 in which a second message 112 is sent from the control unit 10 to the communication system 20. The second message 112 may include user data, such as vehicle data required for contactless vehicle access or for evaluation in a repair facility. The second message 112 is sent after the first message 111 using a preset time interval t1, which may range, for example, between 5 ms and 20 ms. This enables the transmission power to be set before the user data are transmitted, which may be important when only a limited time window t2 is available for the data transmission.

In step 104, the transceiver of the communication system 20 is activated to send a data packet 114 based on the second message 112 to the vehicle key 2 using the UHF transmission power set in step 102. In particular, the communication system 20 evaluates the second message 112, generates a data packet 114 from the user data it contains, and sends the data packet 114 to the vehicle key 2 at the predetermined UHF transmission power.

Before the data packet 114 is transmitted, a communication link with the vehicle key 2 is established or tested, for example by sending at least one ping message 113 using low-frequency (LF) radio communication. If the vehicle key 2 responds to the LF ping message 113, bidirectional communication over UHF may occur between the vehicle key 2 and the communication system 20 of the vehicle 1, enabling the transmission of the data packet 114. However, this is possible only within a limited time window t₂ during which the vehicle key 2 remains in a receive mode triggered by the ping message 113.

Because the transmission power was already set in step 102, the data packet 114 can be transmitted without delay. As a result, in step 105, the vehicle key 2 can receive the data packet 114 transmitted by the vehicle 1 using the predetermined UHF transmission power within the available time window t₂.

In step 106, the vehicle key 2 sends a third message 115 to the vehicle 1. The third message 115 is based on the received data packet 114. For this purpose, the control device of the vehicle key 2 calculates a checksum for the received data packet 114 and transmits the checksum to the vehicle 1 as part of the third message 115.

In step 107, the vehicle 1 receives the third message 115 from the vehicle key 2 via the communication system 20.

In step 108, the communication system 20 checks the checksum received with the third message 115. To perform this check, the communication system 20 may calculate a checksum itself—preferably before transmitting the data packet 114—and temporarily store the checksum in an internal memory. Alternatively, the communication system 20 may temporarily store the data packet 114 for subsequent checksum calculation and comparison.

If the communication system 20 determines that the checksum is incorrect, the system returns to step 104 and re-sends the data packet 114 via the transceiver. This enables verification of whether the data packet 114 was correctly received by the vehicle key 2 and allows retransmission if it was not, thereby improving reliability of data transfer between the vehicle 1 and the vehicle key 2.

### LIST OF REFERENCE NUMERALS

1 vehicle
2 vehicle key
3 system
10 control unit
11 CPU
12 internal memory
20 communication system
21 communication control device
22 transceiver
40 BCM
41 central control device
50 control device
51 CPU
52 internal memory
60 transceiver
70 data memory
101 first method step
102 second method step
103 third method step
104 fourth method step
105 fifth method step
106 sixth method step
107 seventh method step
108 eighth method step
111 first message
112 second message
113 ping message
114 data packet
115 third message
t1 first predetermined time period
t2 second predetermined time period

1. A method of operating a vehicle comprising a control unit and a communication system comprising a communication control device and a transceiver configured for ultra-high-frequency (UHF) communication with a vehicle key, the method comprising:
transmitting, by the control unit to the communication control device, a first message comprising data indicating a UHF transmission power to be set for the transceiver; and
setting, by the communication control device, a UHF transmission power of the transceiver based on the data included in the first message.

2. The method of claim 1, further comprising:
transmitting, by the control unit to the communication control device, a second message comprising user data; and
activating, by the communication control device, the transceiver to send a data packet based on the user data of the second message to the vehicle key using the UHF transmission power set by the communication control device.

3. The method of claim 1, wherein setting the UHF transmission power comprises selecting the UHF transmission power from at least two predetermined UHF transmission powers.

4. The method of claim 3, wherein the predetermined UHF transmission powers comprise a first predetermined UHF transmission power and a second predetermined UHF transmission power, the first predetermined UHF transmission power being less than the second predetermined UHF transmission power.

5. The method of claim 4, wherein:
when the first predetermined UHF transmission power is set, the second message includes data required for a service for the vehicle; and
when the second predetermined UHF transmission power is set, the second message includes data required for an authentication for the vehicle.

6. The method of claim 2, wherein the second message is transmitted after the first message using a preset time interval.

7. The method of claim 2, further comprising:
receiving, by the communication control device via the transceiver, a third message from the vehicle key, the third message comprising a checksum based on the data packet; and
re-sending, by the communication control device, the data packet via the transceiver when the checksum received with the third message does not match a checksum calculated by the communication control device.

8. A vehicle comprising:
a control unit; and
a communication system comprising a communication control device and a transceiver configured for ultra-high-frequency (UHF) communication with a vehicle key,
wherein the control unit is configured to transmit a first message to the communication control device, the first message comprising data indicating a UHF transmission power to be set for the transceiver, and
wherein the communication control device is configured to set a UHF transmission power of the transceiver based on the data included in the first message.

9. The vehicle of claim 8, wherein the control unit is further configured to transmit a second message comprising user data to the communication control device, and wherein the communication control device is further configured to activate the transceiver to send a data packet based on the user data to the vehicle key using the UHF transmission power set based on the first message.

10. The vehicle of claim 9, wherein the communication control device is configured to select the UHF transmission power from at least two predetermined UHF transmission powers.

11. The vehicle of claim 10, wherein the predetermined UHF transmission powers comprise a first predetermined UHF transmission power and a second predetermined UHF transmission power, the first predetermined UHF transmission power being less than the second predetermined UHF transmission power.

12. The vehicle of claim 11, wherein when the first predetermined UHF transmission power is set, the second message includes data required for a service for the vehicle, and wherein when the second predetermined UHF transmission power is set, the second message includes data required for an authentication for the vehicle.

13. The vehicle of claim 9, wherein the second message is transmitted after the first message following a preset time interval.

14. The vehicle of claim 9, wherein the communication control device is further configured to receive, via the transceiver, a third message from the vehicle key comprising a checksum based on the data packet, and wherein the communication control device is further configured to re-send the data packet when the checksum received from the vehicle key does not match a checksum calculated by the communication control device.

15. A vehicle key comprising:
a control device; and
a transceiver configured to communicate with a vehicle via ultra-high-frequency (UHF) radio,
wherein the control device is configured to receive, via the transceiver, a data packet transmitted by the vehicle using a predetermined UHF transmission power.

16. The vehicle key of claim 15, further comprising a data memory, wherein the control device is configured to store the received data packet on the data memory.

17. The vehicle key of claim 16, wherein the control device is further configured to send a message based on the data packet to the vehicle via the transceiver.

18. The vehicle key of claim 17, wherein the control device is further configured to set a UHF transmission power of the transceiver based on the received data packet.

19. The vehicle key of claim 18, wherein the control device is further configured to ascertain a UHF transmission power for the received data packet and to process the received data packet based on the ascertained UHF transmission power.

20. The vehicle key of claim 15, wherein the control device is further configured to place the transceiver into a receive mode for a time window based on a low-frequency ping message received from the vehicle.
